(19) United States
(12) Patent Application Publication
(10) Pub. No.: US 2020/0337323 A1
(43) Pub. Date: Oct. 29, 2020

(54) METHOD FOR PRODUCING FOOD PRODUCTS FROM YOGHURT

(71) Applicant: Zhivko RADEV, SOFIA (BG)

(72) Inventor: Zhivko RADEV, SOFIA (BG)

(21) Appl. No.: 16/962,639

(22) PCT Filed: Jan. 15, 2019
(86) PCT No.: PCT/EP2019/050977

§ 371 Date: Jul. 16, 2020

(30) Foreign Application Priority Data
Jan. 19, 2018 (FR) 1850454

(51) Int. Cl. A23C 9/123; A23C 9/137; A23L 29/231; A23L 33/135; A23L 5/10

(52) U.S. Cl. CPC A23C 9/1232; A23C 9/137; A23L 29/231; A23C 9/1236; A23L 5/10; A23C 9/1234; A23L 33/135

(57) ABSTRACT

The invention relates to a method for producing food products from a yoghurt, the method comprising a step of heating the yoghurt with microwaves at a frequency of between 915 and 2375 MHz and at a temperature of between 60° C. and 65° C. for 10 to 15 seconds, a step of draining the microwave-heated yoghurt, a step of pressing the drained yoghurt then a step of adding at least one emulsifying and/or stabilizing and/or gelling ingredient to the pressed yoghurt.

### BACKGROUND OF THE INVENTION

The soured milk called as well yogurt is derived from lactic fermentation of milk performed with the aid of lactic bacteria named Lactobacillus bulgaricus and Streptococcus thermophilus. The lactic fermentation leads to the thickening of milk and allows the obtainment of the texture and taste characteristics of the yogurt. A large variety of yogurts exist on the market, that could be classified according to their consistency (yogurt drinks, creamy, firm, . . . ) or their taste (natural lactic, fruit, chocolate tastes . . . ). By its nature, yogurt is a perishable foodstuff to be consummated within 30 days maximum of its manufacturing provided that it was stored in refrigerated environment. A large number of yogurt-based food products are manufactured on the grounds of yogurt and have different consistencies. “Tzatziki” for example is an ingenious mixture of thick yogurt and grated cucumbers that could be served as sauce or appetizer. To the contrary, “Lebanon” is a dish consisting of balls of strained yogurt in brine. Although these foodstuffs are kept in refrigerated environment, most of them have a short shelf life not exceeding a few days.

From documents WO2010124224 and WO2014170716 we are aware of yogurt-based manufactured food products having a longer shelf life. However, all of them have a creamy consistency with limited contents of dry matter and pH. Therefore, their variety in consistency and taste is very limited.

### OBJECT OF THE INVENTION

The aim of the invention is to suggest a method of manufacturing foodstuffs on the basis of yogurt, providing a wide range of consistencies and having a long shelf life under normal temperature conditions or refrigerated environment.

### SUMMARY OF THE INVENTION

For the purpose of achieving this object, the invention is proposing a method for the manufacturing of foodstuffs from yogurt consisting of the following stages:
Heating the yogurt under microwaves with frequency between 915 and 2375 megahertz and at a temperature between 60 and 65 degrees Celsius during 10 to 15 seconds,
Strain the yogurt heated under microwaves,
Press the strained yogurt,
Add to the strained yogurt at least one emulsifier and/or stabilizer and/or gelling agent.

Surprisingly, all of these stages make possible to obtain a matter which enables the manufacturing of a wide range of food products of various consistencies and a long shelf life. Thus the inventor could manufacture creamy, spreading, hard, crispy, powdered, ground, etc. products having a shelf life of at least 6 months.

In a specific way of implementation, the ingredient is an emulsifier and/or stabilizer.

In a specific way of implementation, the ingredient contains pectin.

For example, pectin is dissolved in aqueous extract (such as aqueous extract of spice(s)), with an optional ratio of pectin volume to volume of aqueous extract fairly equal to 0.1. The ingredient obtained from the aqueous extract of spice(s) in which pectin is dissolved is also a stabilizer.

The ingredient obtained from the aqueous extract of spice(s) in which pectin is dissolved acts as a hydrocolloid. Thanks to its soluble vegetal fibers, pectin gives to the said ingredient very interesting properties, such as emulsifying, stabilizing and prebiotic.

Optionally, the ingredient is pectin.

Optionally, the ingredient is a aqueous extract of spices having a conserving effect, wherein the pectin is dissolved.

In a specific way the method of manufacturing includes a stage of adding ingredients of animal or vegetal origin.

In a specific way, the method of manufacturing includes a stage of adding probiotics.

According to a specific characteristic, the method of manufacturing includes a stage of correction of pH level of the foodstuff during its manufacturing by adding sodium bicarbonate and/or potassium bicarbonate.

According to a specific characteristic, the method of manufacturing includes a stage of heating the pressed yogurt at a temperature between 65 and 70 degrees Celsius until obtaining a level of dry matter higher than 30%, then at a temperature between 79 and 81 degrees Celsius for 88 to 92 seconds, and then return to a temperature between 65 and 70 degrees Celsius until obtaining a product having a dry matter content between 30% and 44.5%.

In a specific way, the method of manufacturing includes a stage of applying a protective coating on the product against superficial contamination, then a stage of maturation of the given product at a temperature between 2 and 6 degrees Celsius for 1 to 3 months in order to obtain a matured product.

In a specific way, the method of manufacturing includes a stage of grating or reducing to powder of the matured product to obtain a grated or powdered product.

In a specific way, the method of manufacturing comprises a stage of heating the grated or powdered product at a temperature between 65 and 70 degrees Celsius for 20 to 30 minutes.

According to another specific characteristic the method of manufacturing includes a stage of cooking consisting in heating the yogurt during its transformation in food product at a temperature between 90 to 95 degrees Celsius for 30 to 40 minutes and cooling it to 9 to 11 degrees Celsius for less than 60 minutes.

### BRIEF DESCRIPTION OF FIGURES

The invention will be better understood in the light of the following description which is purely illustrative and not restrictive and should be assessed in terms of the attached figures attached, among which:

FIG. 1 is a schematic representation of a first mode of implementation of the invention wherein the food product has a thick consistency and a shelf life between 6 and 24 months under normal temperature conditions;

FIG. 2 is a schematic representation of a second mode of implementation of the invention where the food product has a creamy or spread consistency and a shelf life between 6 to 24 months under normal temperature conditions;

FIG. 3 is a schematic representation of a third mode of implementation of the invention with firm consistency and a shelf life between 6 to 12 months under refrigerated conditions;

FIG. 4 is a schematic representation of a fourth mode of implementation of the invention where the food product is crispy and has a shelf life between 6 to 12 months under refrigerated conditions;

FIG. 5 is a schematic representation of a fifth mode of implementation of the invention where the food product is in the form of powder and has a shelf life between 6 and 12 months under refrigerated conditions.

### DETAILED DESCRIPTION OF THE INVENTION

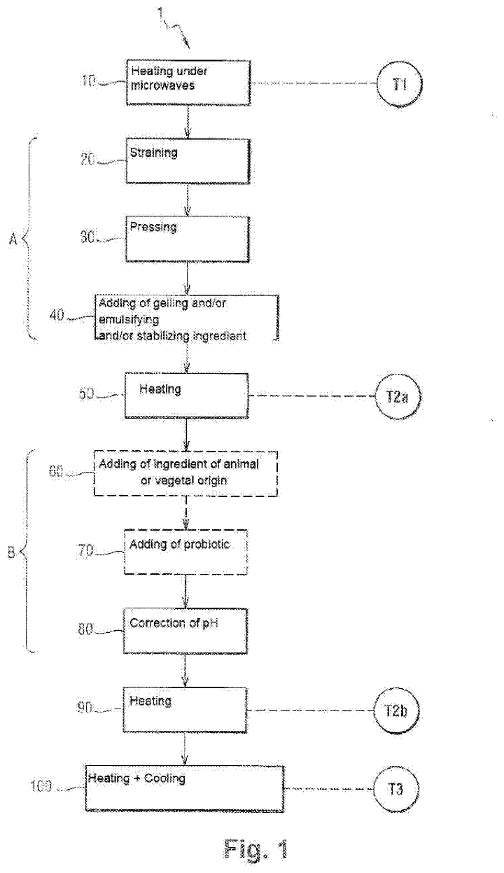

Referring to FIG. 1 and according to the first mode of implementation of the invention, a method of manufacturing 1 refers to the manufacturing of a foodstuff from yogurt Y, the food product having a thick consistency and a shelf life between 6 to 24 months under normal temperature conditions (i.e. under non-refrigerated conditions, thus the food product being subjected to the environment temperature). More specifically, the food product comes in the form of a homogeneous and/or smooth surface Block at cutting. Considering that the manufacturing of yogurt is well known in the prior art, it will not be described in details here. For example, the method of manufacturing 1 (yogurt Y being its basic product) includes the following successive stages:
Receiving and purifying the milk;
Pasteurization of the purified milk at a temperature between 82 to 85° C. (degrees Celsius),
Homogenization of the pasteurized milk at 70° C. and at a pressure between 10 and 12 MPa (Megapascal),
Cooling of the homogenized milk to a temperature between 40 and 45° C.,
Adding of bacteria Lactobacillus bulgaricus and Streptococcus thermophilus, the ratio of Lactobacillus bulgaricus to Streptococcus thermophilus being between 0.25 and 0.50 and the ratio of the total volume of bacteria to the volume of cooled milk being between 0.01 and 0.02,
Stirring of the enriched milk then rest for a period between 20 and 30 minutes;
Filling the stirred milk in packages of 500 to 5000 grams (optionally between 500 and 3000 grams and again optionally between 500 and 1000 grams),
Fermentation of the milk in packages for a time between 3 and 4 hours at a temperature between 40 and 45° C.;
Cooling of the fermented milk for 2 to 3 hours to a temperature of 20° C., then for 4 hours to a temperature of 10° C.
Storing of cooled milk at a temperature between 0 to 6° C. for less than 5 days.

The yogurt Y obtained in such way has a coagulum with firm consistency and lipid content equal to 2%, proteins between 3,2 and 3,3%, dry matter content between 9.5 and 10% and pH (hydrogen potential) between 4 and 4.8.

The method of manufacturing 1 starts from a cooked basic product. For example we start from a firm yogurt (and non-stirred for example).

According to FIG. 1, the method of manufacturing 1 includes a first stage 10 consisting in heating the yogurt Y under microwaves at a frequency between 915 and 2375 MHz and at a temperature between 60 and 65° C. for 10 to 15 seconds, in order to perform a first heat treatment T1 of yogurt Y. Heating under microwaves has the effect of causing the formation of whey, called as well lactic serum or lactoserum resulting from the heated coagulum.

Contrary to the other heating methods based on the transmission of heat, heating under microwaves provides for a relatively even and quick heating of yogurt Y.

On the one hand it helps improve the yield. On the other hand, it limits the denaturation of proteins contained in the coagulum. Moreover, the absence of moulds and yeasts in the yogurt is assured.

The first stage 10 can be performed in a heating continuous-action tunnel or in a discontinuous-action chamber.

Once the first stage has ended, during the second stage 20, the yogurt heated under microwaves is strained for a time period between 12 and 18 hours at a temperature between 2 and 6° C. Straining permits the separation of the compact part of the yogurt called coagulum from the liquid part called whey or lactic serum. This separation is performed with the help of a drumstrainer or a straining cloth.

Advantageously, during this stage, the yogurt is subject to a self-compaction under its own weight until it reaches a dry content level between 19 to 19.5% and PH between 3.8 and 3.95. At the end of the second stage 20, the ratio volume of lactic serum and volume of coagulum is substantially equal to 2.

Once the second stage has ended, a third stage 30 starts, consisting of pressing the strained yogurt for a duration of between 8 to 12 hours at a temperature again between 2 and 6° C.

This third stage 30 can for example be performed with a dairy press.

The pressing of strained yogurt results in increasing the dry matter content of strained yogurt.

During this third stage it is still possible to extract from the strained yogurt an additional 22 to 25% of lactic serum.

During pressing, lactic microorganisms continue to decompose the sugar of the yogurt (also called lactose) to reduce it into lactic acid. Thus, the third stage 30 has the effect to increase the dry matter content and decrease the pH which now are respectively between 24 and 25% and 3.6 and 3.8.

Once the third stage 30 is completed, during a fourth stage 40 the following are added to the pressed yogurt:
An ingredient which is an aqueous extract of a spices with preservative effects (turmeric and/or mustard and/or allspice and/or cloves and/or thyme and/or rosemary and/or sage . . . ), and
An ingredient which in this case is s soluble pectin in aqueous extract of spices with preservative effects, the ratio between the volume of pectin and the volume of aqueous extract being substantially equal to 0.1.

This aqueous extract containing pectin comes in the form of gel.

The ratio between the aqueous extract containing pectin and the volume of yogurt is normally between 10 and 20%.

The aqueous extract and the soluble pectin have the effect to increase the shelf life of the food product by their anti-bacterial and bacteriostatic activities and to stabilize the taste of the food product.

Moreover, pectin being an emulsifier and hydro-colloid, hinders the syneresis and the denaturation of proteins during further heat treatment.

Once the fourth stage 40 is completed, a homogenization and a second heat treatment T2 of the yogurt with additives take place. Preferably, the use of a mixer equipped with heating devices permits to implement simultaneously such homogenization and the second heat treatment T2.

A first phase T2a of the second heat treatment T2 consists in heating, during a fifth stage 50, the yogurt with additives at a temperature between 65 and 70° C. until obtaining a dry matter content of the yogurt with additives above 30%.

At the end of the fifth stage 50, additional ingredients of animal origin (eggs, meat . . . ) or vegetal origin (fruits, vegetables, . . . ) can be added during the sixth optional stage 60. Thus different varieties of tastes could be given to the food products.

Likewise, one or more probiotics, notably ones with beneficial effect on digestion could be added during the seventh optional stage 70.

Once stages 50, 60 and 70 are completed, starts the implementation of an eighth 80 stage. It consists in measuring, then correcting the pH of the yogurt transformed by the above 7 stages by adding sodium bicarbonate and potassium bicarbonate in the yogurt in order to obtain a value higher than 4.9 and more specifically between 5 and 5.8.

Once the eighth 80 stage is completed, during a ninth stage 9, a second phase T2b of the second heat treatment T2 is performed consisting of heating the yogurt at a temperature of 80° C. for 90 seconds, then at a temperature between 65 and 70° C. until obtaining a product with dry matter content between 30 and 44.5%. The obtained product is soft and firm, i.e. easy to shape.

The second heat treatment T2 makes possible to replace the pasteurization and to interrupt the lactic fermentation process by deactivating the enzymes.

Then the product is packed in unit doses in hermetic packages, for example such as glass jars with caps (best known by their English name “twist-off”). The packing in unit doses could be carried out on a processing line in a continuous or discontinuous manner.

Then the packed product is submitted to a third heat treatment T3 during a tenth stage 100 to proceed to a boiling followed by a cooling of the packed product. Boiling consists in heating the packed product in water or with steam at a temperature between 90 and 95° C. for 30 to 40 minutes. Boiling could be performed in heating discontinued-action chamber or in continued-action heating tunnel. Then the boiled product is cooled to a temperature substantially close to 10° C. for less than 60 minutes. Cooling could be performed in a discontinued-action cooling chamber or in a continued-action cooling tunnel.

Compared to the sterilization in autoclave (best known by the English term of “retort”sterilization) or to UHT sterilization (Uperization High Temperature) performed at temperatures higher than 100° C., boiling during heat treatment T3 allows to preserve the nutrition qualities of the product and guarantee a microbiological purity and a long shelf life of the product.

Thus, the product obtained after the third heat treatment T3 represents the food product obtained by the method of manufacturing 1 which, if stored under normal temperature conditions, could be kept for a period of 6 to 24 months. Dry matter content, protein content and pH of the food product are respectively between 30 and 44.5%, between 10 and 21% end between 5 and 5.8.

The table below gives examples of food products obtained by implementing the method of manufacturing 1:

| | Result | Result | Result | Result |
|---|---|---|---|---|
| | Product | Product | Product | Product |
| Test type | RN6204 | RN6206 | RN6207 | RN6208 |
| Dry matter | 43.94 | 33 | 36.19 | 44.33 |
| content (%) | | | | |
| pH | 5.23 | 5.76 | 5.32 | 5.36 |
| Consistency | Compact | Compact | Compact, | Homogenous |
| | product | product | homogenouswith | with pieces of ham |
| | | | pieces of red | |
| | | | paprika | |
| Taste | Lactic, | Lactic, olive | Lactic, egg taste | Lactic with ham |
| | seasoned with | taste | with hints of | taste |
| | turmeric | | roasted red | |
| | | | paprika | |
| Flavour | Lactic, with | Lactic, with olive | Lactic flavour | Lactic |
| | turmeric flavour | flavour | | |
| Colour | Light yellow | Black olives | Yellow with red | Milky white |
| | | paste | pieces and | with pieces of |
| | | | strands | ham |
| External | Homogenous | Homogenous | Smooth surface | Smooth surface |
| aspect | Block with | bloc | at cutting | at cutting |
| | smooth surface | | | |
| | at cutting | | | |
| Protein | 19.81 | 10.31 | 15.02 | 20.35 |
| content (%) | | | | |

The long shelf life of a food product manufactured by one of the methods of implementation of the invention could be verified by making microbiological studies of such product. The table below provides the analysis results of the examples of food products obtained by implementing the method of manufacturing 1:

Microbiological Parameters (dry matter 30-44, 5%, PH 5-5,8, proteins 10-21%)
RN 6204: Food product of cooked yogurt with aqueous extract of turmeric
RN 6206: Food product with black olive paste and aqueous extract of mustard.
RN 6207: Food product of cooked yogurt and roasted
paprika with aqueous extract of mustard
RN 6208: Food product of cooked yogurt and ham with
aqueous extract of cloves and allspice

| | Unit of | | |
|---|---|---|---|
| | mesure | Result | Test conditions |
| Salmonella | ufc/25 g | Non | 37.0 +/− 0.1° C. |
| | | detectable | |
| Moulds and yeasts | ufc/g | <10 | 25.0 +/− 0 1° C. |
| | | | Thermostated for 14 |
| | | | days at 37° C. |
| Spores of mesophile anaerobic | ufc/g | <10 | 37.0 +/− 0.1° C. |
| microorganisms and optional | | | Thermostated for 14 |
| anaerobic microorganisms | | | days at 37° C. |
| Coliforms | ufc/g | <1 × 10\hat{ }1 | 37.0 +/− 0.1° C. |
| Coagulase-positive Staphylococci | ufc/g | <1 × 10\hat{ }2 | 37.0 +/− 0.1° C. |
| Mesophiles aerobic and optional | — | Non | 37.0 +/− 0.1° C. |
| anaerobic microorganisms | | detectable in | Thermostated for |
| | | 1 gr. | 14 days at 37° C. |
| Mesophiles anaerobic | — | Non | 37.0 +/− 0.1° C. |
| microorganisms | | detectable | Thermostated for 14 |
| | | dans 1 gr. | days at 37° C. |

We must remind here that the acronym UFC means “unite formant colonie” (better known by the English acronym “CFU” standing for “colony-forming unit).

In order to simplify the rest of the description of the first mode of implementation of the invention, the second stage 20, third stage 30 and fourth stage 40 of the first mode represent a first sequence of stages A that could be summarized as follows:
Straining of heated yogurt (stage 20),
Pressing of strained yogurt (stage 30),
Adding of gelling agent and/or emulsifier and/or stabilizer to the pressed yogurt (stage 40).

Likewise, the sixth stage 60, seventh stage 70 and eighth stage 80 represent a second sequence of stages B that could be summarized as follows:
Optional addition of additional ingredient of animal or vegetal origin (stage 60),
Optional addition of probiotics (stage 70),
Correction of pH (stage 80).

As illustrated in FIG. 1, the method of manufacturing 1 could be schematized in the following way:
Neat treatment T1
First sequence of stages A
First phase T2a of heat treatment T2
Second sequence of stages B
Second phase T2b of heat treatment T2
Heat treatment T3

According to a second mode of implementation of the invention, the method of manufacturing 2 concerns the manufacturing of a food product from an yogurt Y, the food product having a creamy consistency or spread consistency and a shelf life between 6 to 24 months under normal temperature conditions (i.e. under non-refrigerated conditions, thus the food product being subject to the environment temperature). Yogurt Y is for example the same as the one in the first mode of implementation.

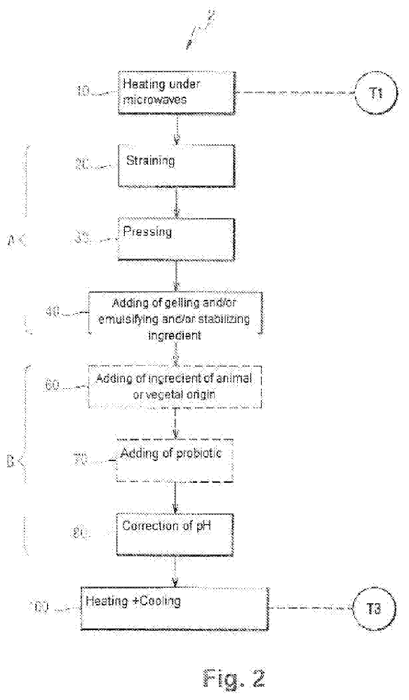

In conformity with FIG. 2, the method of fabrication 2 is similar to the method 1 with the difference that the second heat treatment T2 is not performed. Only the first heat treatment T1 and the third heat treatment T3 are carried out. Therefore, the method of manufacturing 2 could be schematized in the following way:
Heat treatment T1
First sequence of stages A
Second sequence of stages
Heat treatment T3

The method of manufacturing 2 could also include a stage of homogenization. At the end of the third heat treatment T3, the cooled product forms the food product deriving from the method of manufacturing 2 which, if stored under normal temperature conditions, could be kept for a time period between 6 and 24 months. The dry matter content of the food product is between 18 and 33% and pH between 4 and 5.65.

The table below gives examples of food products obtained by implementing the method of manufacturing 2:

| | Result | Result | Result | Result |
|---|---|---|---|---|
| Test type | PN4007 | PN4008 | RN6764 | RN6765 |
| Dry matter | 19.52 | 18.39 | 18.82 | 32.63 |
| content (%) | | | | |
| PH | 4.49 | 4.22 | 5.63 | 5.17 |
| Consistency | Pasty | Homogenous | Smooth | Creamy |
| | consistency to | with pieces of | surface | |
| | be spread | roasted red | product, | |
| | | paprika 1-2 | homogenous | |
| | | mm | | |
| Taste | Lactic mixed | Lactic with egg | Lactic, lightly | Sweet taste of |
| | | taste with | salted, with | cocoa mixed |
| | | hints or | sunflower, | with coconut |
| | | roasted red | thyme, and | |
| | | paprika | rosemary | |
| | | | taste. | |
| Flavour | Lactic mixed | | Lactic with | Lactic of cocoa |
| | with olive | | sunflower, | mixed with |
| | flavour | | thyme and | coconut flavour |
| | | | rosemary | |
| Colour | Light brown | Light yellow | Light gray | Dark cocoa with |
| | colour of | with red | | dots of coconut |
| | olives paste | pieces and | | |
| | | dark green | | |
| | | strands | | |
| External | | | For cutting, | |
| aspect | | | spreading. | |
| | | | Light gray, | |
| | | | smooth surface | |
| Protein | | | 3.35 | 1.47 |
| content (%) | | | | |

The long shelf life of a food product manufactured by one of the methods of implementation of the invention could be verified by making microbiological studies of such product. The table below provides the analysis results of the examples of food products obtained by implementing the method of manufacturing 2.

Microbiological parameters (dry matter 18-33%, PH 4-5.65)
PN 4007: Food product of cooked yogurt with olives paste and
aqueous extract of mustard
RN 6764: Food product of lactic serum of cooked yogurt, sunflower
seeds and aqueous extract of thyme and rosemary
RN6765: Foodproductoflacticserumofcookedyogurt, withgrated coconut,
flour of carob beans and aqueous extract of sage.

| | Unit of | | |
|---|---|---|---|
| Type tested characteristics | measure | Result | Test conditions |
| Salmonella | ufc/25 g | Non | 37.0 +/− 0.1° C. |
| | | detectable | |
| Moulds and yeasts | ufc/g | <10 | 25.0 +/− 0.1° C. |
| Spores of mesophile anaerobic | ufc/g | <10 | 37.0 +/− 0.1° C. |
| microorganisms and optional | | | Thermostated for |
| anaerobic microorganisms | | | 14 days at 37° C. |
| Coliforms | ufc/g | <1 × 10\hat{ }1 | 37.0 +/− 0.1° C. |
| Coagulase-positive | ufc/g | <1 × 10\hat{ }2 | 37.0 +/− 0.1° C. |
| Staphylococci | | | |
| Mesophiles aerobic and optional | — | Non | 37.0 +/− 0.1° C. |
| anaerobic microorganisms | | detectable | Thermostated for |
| | | in 1 gr. | 14 days at 37° C. |
| Mesophiles anaerobic | — | Non | 37.0 +/− 0.1° C. |
| microorganisms | | detectable | Thermostated for |
| | | in 1 gr. | 14 days at 37° C. |

According to a third mode of implementation of the invention, a method of manufacturing 3 concerns the manufacturing of a food product from an yogurt Y, the food product having a firm consistency and a shelf life between 6 to 12 months under refrigerated conditions. Yogurt Y is for example the same as the one in the first mode of implementation.

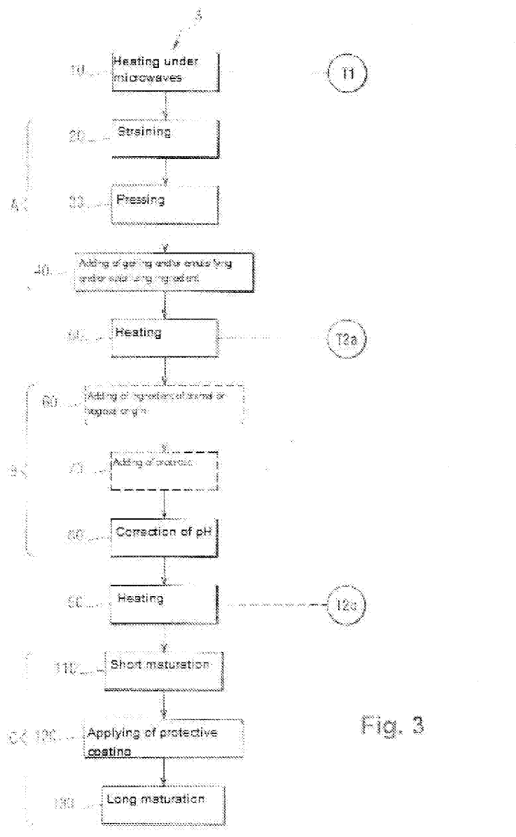

In conformity with FIG. 3, the method of fabrication 3 is almost similar to the method 1 with the difference that the third heat treatment T3 is replaced by a third sequence of stages C. Only the first heat treatment T1 and the second heat treatment T2 are carried out. Therefore, the method of manufacturing 3 could be schematized in the following way:
Heat treatment T1
First sequence of stages A
First phase T2a of heat treatment T2
Second sequence of stages B
Second phase T2b of heat treatment T2
Third sequence of stages C

The second phase T2b of heat treatment T2 is implemented here in order to obtain a product having dry matter content between 40 and 42%.

The product is then packed in moulds to be stored during an eleventh stage 110 at a temperature between 2 and 6° C. for a time between 24 and 48 hours. During this short maturation the product is subjected to self-compaction and noticeably increases its dry matter content.

At the end of the eleventh stage 110 the matured product is unmolded to get a protective surface coating applied, thus forming a twelfth stage 120. The protective coating prevents de contamination of the surface by using for example coconut oil.

The protected product is then stored again during a thirteenth stage 130 at a temperature between 2 and 6° C. for 1 to 3 months according to the size of the packed product. During this long maturation it is again subjected to self-compaction and noticeably increase of its dry matter content.

The eleventh stage 110, twelfth stage 120 and thirteenth stage 130 constitute the third sequence of stages C that could be summarized in the following way:
Short maturation (stage 110),
Protective coating application (stage 120),
Long maturation (stage 130).

At the end of the thirteenth stage 130, the long time matured product forms the food product deriving from the method of manufacturing 3, which if stored under refrigerated conditions could be kept for a period between 6 to 12 months. The dry matter content, protein content and pH of the food product are respectively between 41 and 66%, between 19 and 21% and between 4.3 and 5.5.

The table below gives examples of food products obtained by implementing the method of manufacturing 3:

| | Result | Result | Result | Result |
|---|---|---|---|---|
| | Product | Product | Product | Product |
| Test type | RN4828 | RN4827 | PN4006 | PN4005 |
| Dry matter | 41.83 | 51.48 | 54.09 | 65.21 |
| content (%) | | | | |
| PH | 4.32 | 4.43 | 5.46 | 5.08 |
| Consistency | Firm product | Firm product | Firm, | Firm, |
| | | | homogenous, | homogenous, |
| | | | with smooth | with smooth |
| | | | surface at | surface at cutting |
| | | | cutting | |
| Taste | Lactic, cheese | Lacitc, | Lactic, hints of | Lactic, cheese |
| | taste | cheese taste | cheese and | taste |
| | | | potatoes | |
| Flavour | Lactic with | Lactic with | Lactic with | Lactic with |
| | coconut oil | coconut oil | coconut oil | coconut oil |
| | flavour | flavour | flavour | flavour |
| Colour | Light beige | Outside light | Light to milky- | Light to milky- |
| | outside, milky | colour of | cream colour | cream colour |
| | white inside | coconut oil | | |
| External | Homogenous | Homogenous | Smooth | Smooth surface, |
| Aspect | block | block | surface, fat | fat coated |
| | | | coated | |
| Protein | 19.15 | 20.96 | | |
| content (%) | | | | |
| Duration of | 48 H - fresh | 9 weeks | 10 weeks | 16 weeks |
| maturation | product | | | |

The long shelf life of a food product manufactured by one of the methods of implementation of the invention could be verified by making microbiological studies of such product.

The table below provides the analysis results of the examples of food products obtained by implementing the method of manufacturing 3.

Microbiological parameters
(dry matter41-66%, PH 4.3-5.5, proteins 19-21%)
PN 4006: Firm food product of cooked yogurt, matured for 3 months
PN 4005: Firm food product of cooked yogurt, matured for 2 months

| | Unit of | | |
|---|---|---|---|
| Type of tested characteristic | measure | Result | Test conditions |
| Salmonella | ufc/25 g | Non | 37.0 +/− 0.1° C. |
| | | detectable | |
| Listeria monocytogenes | ufc/25 g | Non | 37.0 +/− 0.1° C. |
| | | detectable | |
| Escherichia coli | ufc/g | <1 × 10\hat{ }1 | 44.0 +/− 0.1° C. |
| Coagulase-positive | ufc/g | <1 × 10\hat{ }2 | 37.0 +/− 0.1° C. |
| staphylococci | | | |

According to a fourth mode of implementation of the invention, a method of manufacturing 4 concerns the manufacturing of a crispy food product from yogurt Y with a shelf life between 6 to 12 months under refrigerated conditions. Yogurt Y is for example the same as the one in the first mode of implementation.

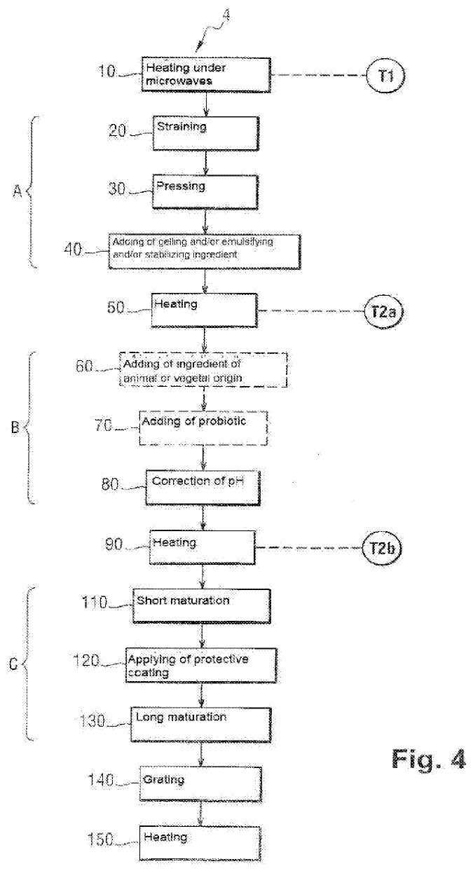

In conformity with FIG. 4, the method of manufacturing 4 consists in the implementation of all stages of method of manufacturing 3, plus a fourteenth stage 140 and fifteenth stage 150 consisting respectively in grating the long time matured product and heating it at a temperature between 65 and 70° C. for 20 to 30 minutes in order to obtain a golden colour. The long time matured product is normally grated in strands 1.5 to 2 mm long forming a layer 3 to 5 mm. thick.

The table below gives an example of a food product obtained by the implementation of the method of manufacturing 4:

| Test type | Result PN4143 |
|---|---|
| Dry matter content (%) | 85.33 |
| PH | 4.42 |
| Consistency | Crispy product |
| Taste | Cheese taste with hints of potatoes |
| Flavour | Lactic with potatoes flavor |
| Colour | Golden -sample No 8 |
| External aspect | Strands 1.5-2 mm thick |
| Protein content ( % ) | 32.01 |

According to a fifth mode of implementation of the invention, a method of manufacturing 5 concerns the manufacturing of a food product in powder from yogurt with a shelf life between 6 to 12 months under refrigerated conditions. Yogurt Y is for example the same as the one in the first mode of implementation.

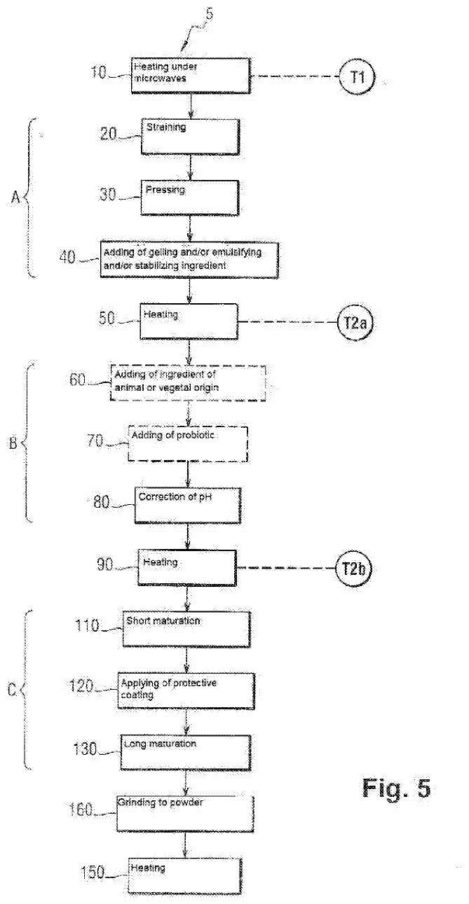

According to FIG. 5, the method of manufacturing 5 is similar to the method of manufacturing 4 with the difference that the long time matured product is not grated but ground in powder during a sixteenth 160 stage before being heated in order to obtain a golden colour.

The table here-below gives an example of food product obtained by the implementation of the method of manufacturing 5:

| Test type | Result Product RN4826 |
|---|---|
| Dry matter content (%) | 91.74 |
| PH | 3.31 |
| Consistency | Flour-like consistency |
| Taste | Lactic, cheese taste |
| Flavour | Lactic |
| Colour | White |
| External aspect | Product in powder form |
| Protein content (%) | 40.79 |

So, we have seen that starting from the same basic product (yogurt Y) we could manufacture numerous different food products.

All of the previously described modes of implementation include the first heat treatment, the first sequence of stages A and at least one of the second and third heat treatments.

Of course, the invention is not limited to the modes of implementation described, but includes any variant within the range of the invention, as defined in the claims.

Hence, we could use the lactic serum derived from straining and pressing of yogurt to manufacture other food products.

If we use pectin, it could be pectin from apples, such as but not exclusively, pectin dissolved in an aqueous extract of spices.

1. Method of manufacturing of food products from yogurt including the following stages:
Heating the yogurt under microwaves at a frequency between 915 and 2375 megahertz and at a temperature between 60 and 65 degrees Celsius for 10 to 15 seconds,
Straining the yogurt heated under microwaves,
Pressing the strained yogurt,
Adding at least one emulsifying and/or stabilizing and/or gelling ingredient to the pressed yogurt.

2. Method of manufacturing as per claim 1, where the ingredient contains pectin.

3. Method of manufacturing as per claim 2, where the ingredient is an aqueous extract of spices with preserving effect, containing dissolved pectin.

4. Method of manufacturing as per claim 1, containing a stage of adding ingredients of animal or vegetal origin.

5. Method of manufacturing as per claim 1, containing a stage of adding probiotics.

6. Method of manufacturing as per claim 1, including a stage of correction of the food product's pH during its manufacturing by addition of sodium bicarbonate and/or potassium bicarbonate.

7. Method of manufacturing as per claim 1, containing a stage of heating the pressed yogurt at a temperature between 65 to 70 degrees Celsius to obtain a dry matter content well over 30%, then at a temperature between 79 and 81 degrees Celsius for 88 to 92 seconds, to return to a temperature between 65 to 70 degrees Celsius until obtaining a product with dry matter content between 30% and 44.5%.

8. Method of manufacturing as per claim 7 including a stage of applying a preserving coating on a given product against surface contamination, then a stage of maturation of the given product covered with its protective coating at a temperature between 2 and 6 degrees Celsius for 1 to 3 months to obtain a matured product.

9. Method of manufacturing as per claim 8, including a stage of grating or reducing to powder of the matured product to obtain a grated or powdered product.

10. Method of manufacturing as per claim 9, containing a stage of heating the grated or powdered product at a temperature between 65 and 70 degrees Celsius for 20 to 30 minutes.

11. Method of manufacturing as per claim 1, containing a stage of cooking consisting in heating the yogurt during its processing into a food product at a temperature between 90 and 95 degrees Celsius for 30 to 40 minutes and cooling it to between 9 and 11 degrees Celsius for less than 60 minutes.
